(19) United States
(12) Patent Application Publication
(10) Pub. No.: US 2023/0316051 A1
(43) Pub. Date: Oct. 5, 2023

(54) PRE-ALARMING METHOD FOR ROTARY STALL OF COMPRESSORS BASED ON TEMPORAL DILATED CONVOLUTIONAL NEURAL NETWORK

(71) Applicant: DALIAN UNIVERSITY OF TECHNOLOGY, Dalian, Liaoning (CN)

(72) Inventors: Ximing SUN, Dalian, Liaoning (CN); Yuhui LI, Dalian, Liaoning (CN); Fuxiang QUAN, Dalian, Liaoning (CN)

(21) Appl. No.: 17/795,095

(22) PCT Filed: Sep. 18, 2021
(86) PCT No.: PCT/CN2021/119187

§ 371 Date: Jul. 25, 2022

(30) Foreign Application Priority Data
Aug. 6, 2021 (CN) 202110899542.7

(51) Int. Cl. G06N 3/049; F04D 27/00; G06N 3/048; G06N 3/0455

(52) U.S. Cl. CPC G06N 3/049; F04D 27/001; G06N 3/048; G06N 3/0455

(57) ABSTRACT

A pre-alarming method for rotary stall of compressors based on a temporal dilated convolutional neural network includes firstly, preprocessing dynamic pressure data of an aero-engine, and dividing a test dataset and a training dataset from experimental data; secondly, constructing a temporal convolutional network module, a Resnet-v network module and a temporal dilated convolutional network prediction model in sequence, and saving an optimal prediction model. Finally, conducting real-time prediction on test data: adjusting data dimension of the test dataset according to input requirements of the temporal dilated convolutional network prediction model; calculating predicted surge probability of each sample by the temporal dilated convolutional network prediction model in chronological order; calculating real-time surge probability of a pair of samples with and without covariates by the temporal dilated convolutional network prediction model, and observing improvement action of covariates on model prediction effect.

### TECHNICAL FIELD

The present invention relates to a pre-alarming method for rotary stall of compressors based on a temporal dilated convolutional neural network, and belongs to the technical field of aero-engine modeling and simulation.

### BACKGROUND

Performance stability of an aero-engine is directly related to the flight safety of the whole engine, and the stability maintaining function of pneumatic components in terms of overall flow, pressure and energy influences the overall operating state of the engine. Among various common gas path faults, rotary stall of compressors is a fault which is extremely destructive and changes rapidly; therefore, accurate identification and timely pre-alarming of rotary stall of compressors is a research focus in aero-engine field at home and abroad. Generally, the development process of compressor instability mainly includes four stages: steadystate, stall inception, rotary stall and surge, and the stages have different characteristics, relatively complex mechanisms and very rapid propagation. When a compressor operates steadily, the compressor flow is decreased and the pressure ratio is increased; when the flow is decreased beyond an instability boundary, flow instability will occur in the compressor, thus resulting in rotary stall or surge, and flow fluctuation will be extremely violent. When surge occurs, mechanical components in the engine are often substantially damaged; therefore, it is urgently needed to stop an engine instability process at an early stage of the rotary stall, i.e., to identify early signs of minor faults before the components are damaged, thus to allow more time for active control.

Detection of rotary stall is usually based on the characteristics of inception signals extracted from fluctuating pressure signals of the compressor, and a detection algorithm mainly includes time domain analysis, frequency domain analysis and time-frequency analysis. In time domain analysis, detection is realized based on the time domain characteristic variation of the pressure signals through analysis of variance and correlation analysis, thus time domain analysis is fast in computation speed and convenient for engineering application, but is highly dependent on a signal amplitude, poor in stability and susceptible to noise. In frequency domain analysis, detection is realized by analyzing the characteristic variation of a signal spectrum diagram, but signal stationarity is required as a precondition, so the application of frequency domain analysis is limited. In time-frequency analysis, time domain information and spectrum signatures are combined, and the dimension of information analysis is increased, thus time-frequency analysis can be used to better analyze non-stationary signals, but has a poor generality for stall signals with large morphological differences.

### SUMMARY

In view of problems of low accuracy and poor reliability in the prior art, the present invention provides a pre-alarming method for rotary stall of compressors based on a temporal dilated convolutional neural network.

The present invention adopts the following technical solution:

A pre-alarming method for rotary stall of compressors based on a temporal dilated convolutional neural network, comprising the following steps:

S1. Preprocessing surge data of an aero-engine, comprising the following steps:

S1.1. Importing experimental data of a measuring point and taking the experimental data as a dataset to conduct filtering processing on pressure variation data by a low pass filter;

S1.2. Conducting downsampling on the filtered data; and selecting a downsampling rate according to numerical distribution interval of surge frequency and based on Nyquist sampling theorem;

S1.3. Conducting normalization processing on the downsampled data, and mapping data distribution to an interval [0, 1] by linear variation;

S1.4. Constructing a dataset sample by a sliding window technique, sharding time domain data in units of time steps with a size of “steps”, constituting a sample by sampling points covered by each data window, and attaching a label of 1 or 0 for surge or not to each sample;

S1.5. Dividing an overall dataset into a training dataset and a test dataset, and then dividing the training dataset into a training set and a validation set with a ratio of 3:1;

S2. Constructing a temporal convolutional network module, comprising the following steps:

S2.1. Adjusting dimension of each sample to (steps, 1), and taking same as an input of the temporal convolutional network module, wherein “steps” represents the time steps;

S2.2. Constructing dilated convolutional modules based on causal convolution and dilated convolution, wherein basic modules in each layer of a temporal convolutional network are composed of two dilated convolutional modules with the same kernel size and dilated factor value; conducting batch normalization after a first dilated convolution, introducing a rectified nonlinear unit ReLU to adjust information passed to a next layer, conducting batch normalization again after a second dilated convolution, summing obtained characteristics and characteristics extracted from a previous layer, and calculating output characteristics of a current layer by a ReLU activation function;

S2.3. Constructing a temporal dilated convolutional neural network by stacking multiple dilated convolutional modules, expanding network reception field, reserving output information of each convolutional layer by skip connection, and obtaining an output of the temporal convolutional network module through activation by the ReLU activation function;

S3. Constructing a Resnet-v network module, comprising the following steps:

S3.1. Considering characteristics of the surge data, allowing two parts of data input in a designed Resnet-v network, wherein one part is historical data characteristics and the other part is data covariates; calculating time domain statistical characteristics of each sample, including the data characteristics such as variance, mean, maximum and minimum, and serial number of a measuring point corresponding to the sample, forming a set of covariate characteristics, and taking the covariate characteristics as one of the inputs of the Resnet-v network module;

S3.2. Processing input covariates through a set of dense layer and BN layer, and applying the ReLU activation function to pass the covariates to a next set of dense layer and BN layer; summing an output thereof and the data characteristics obtained by the temporal convolutional network, and obtaining an output of the Resnet-v network by the ReLU activation function;

S4. Constructing a temporal dilated convolutional network prediction model, comprising the following steps:

S4.1. Constructing a temporal dilated convolutional network prediction model by an architecture similar to Seq2Seq architecture, and dividing the model into an Encoder module and a Decoder module, wherein the Encoder module is a temporal convolutional network module, and the Decoder module is composed of a Resnet-v network module and an output dense layer;

S4.2. Inputting an output characteristic hₜ of the Encoder module into the Resnet-v network module, and conducting an operation according to step S3 to obtain a fusion output;

S4.3. Receiving the fusion output obtained in the previous step by the output dense layer of the Decoder module, and processing by the dense layers, the BN layers, the ReLU activation function, etc. to obtain a predicted value of surge probability;

S4.4. In view of problems in surge data training, taking MHL (Modified HuberLoss) as a loss function; as a loss function with a higher robustness, HuberLoss can effectively combine the advantages of MSE and MAE, and avoid the problem of MAE being nondifferentiable when the value is 0 and the disadvantage of MSE being greatly influenced by outliers. A formula thereof is:

$${L}_{δ} ( y , f ( x ) ) = \{ \begin{matrix}\frac{1}{2} {( y - f ( x ) )}^{2} , & \vert y - f ( x ) \vert \leq δ \\ δ \vert y - f ( x ) \vert - \frac{1}{2} {δ}^{2} , & \vert y - f ( x ) \vert > δ\end{matrix}$$

Where y represents a real data value, f(x) represents a currently predicted value, δ is a hyperparameter that determines how to calculate an error, and L_{δ}(y, f(x)) is a currently calculated loss value.

In addition, introducing an influence factor β(β∈[0,1]) to represent influence degree of a sample in a surge state (category 1) being incorrectly classified as in a non-surge state (category 0), and defining a weight coefficient β₀₋₁ as:

$${β}_{0 - 1} = \{ \begin{matrix}β , & y = 1 \\ 1 - β , & y = 0\end{matrix}$$

Finally, a form of the loss function being MHL=β₀₋₁L_{δ}(y, f(x)).

S4.5. Saving a trained model and testing on the validation set, adjusting the hyperparameter of the model according to an evaluation index of the validation set, adopting an F_score index as the evaluation index, saving a model which makes the evaluation index optimal, and obtaining a final temporal dilated convolutional network prediction model;

The F_score index is as follows:

$${F}_{score} = ( 1 + {β}^{2} ) * \frac{P \cdot R}{{β}^{2} * P + R}$$

Where P is precision, which represents percentage of true positive samples in samples classified as positive:

$$P = \frac{TP}{TP + FP} ,$$

TP is a true positive number, and FP is a false positive number; R is recall, which represents percentage of correctly predicted positive samples in the samples:

$$R = \frac{TP}{TP + FN} ,$$

TP is a true positive number, and FN is a false negative number. Because the loss caused by predicting a positive sample as a negative sample, i.e., predicting a surge sample as a non-surge sample is greater, setting β to 2, and increasing the importance of recall in the evaluation index.

S5. Conducting real-time prediction on test data

S5.1. Obtaining test set data divided after preprocessing in step SI, and adjusting dimension of the data according to input requirements of the temporal dilated convolutional network prediction model;

S5.2. Calculating predicted surge probability of each sample by a trained temporal dilated convolutional network prediction model, and sorting in chronological order;

S5.3. Randomly selecting a set of dynamic pressure data from the test data, sorting the data input to the model into a set of control samples with covariable parameters and a set of control samples without covariable parameters, and using the trained temporal dilated convolutional network prediction model to respectively give real-time surge probabilities of two sets of control data, thus to observe the help of covariates to model prediction effect.

The present invention has the following beneficial effects:

Compared with the previous method of time domain analysis, the method provided by the present invention, when used for pre-alarming rotary stall of compressors, integrates variation tendency and time domain statistical characteristic covariates, thereby improving the prediction precision. As the output of the model is predicted surge probability, different threshold values can be set to divide the probability to realize classified alarm, and the operating state of the engine is adjusted according to surge probability, so that the method is beneficial to improving the performance of active control of the engine. The present invention is based on data and is independent of engine structures; therefore, by training different datasets, the model can be conveniently migrated to different types of engines for use, making the present invention have certain universality.

### DESCRIPTION OF DRAWINGS

FIG. 1 is a flow chart of a pre-alarming method for rotary stall of compressors based on a temporal dilated convolutional neural network;

FIG. 2 is a flow chart of data preprocessing;

FIG. 3 is a structural diagram of a temporal convolutional network;

FIG. 4 is a structural diagram of a Resnet-v network;

FIG. 5 is a structural diagram of a temporal dilated convolutional network prediction model;

FIG. 6 is a diagram showing predicted results of a temporal dilated convolutional network prediction model on test data, wherein (a) is a diagram showing that dynamic pressure at a tip region of an inlet zero-stage stator varies with time, (b) is a diagram showing that predicted surge probability given by the temporal dilated convolutional network prediction model varies with time, and (c) is a diagram showing a pre-alarming signal given by the temporal dilated convolutional network prediction model; and

FIG. 7 is a comparison diagram showing influence of covariates on prediction effect of a temporal dilated convolutional network prediction model, wherein (a) is a diagram showing that dynamic pressure at a tip region of an inlet second-stage stator varies with time, (b) is a diagram showing that predicted surge probability varies with time when an input contains no covariates, and (c) is a diagram showing that predicted surge probability varies with time when the input contains covariates.

### DETAILED DESCRIPTION

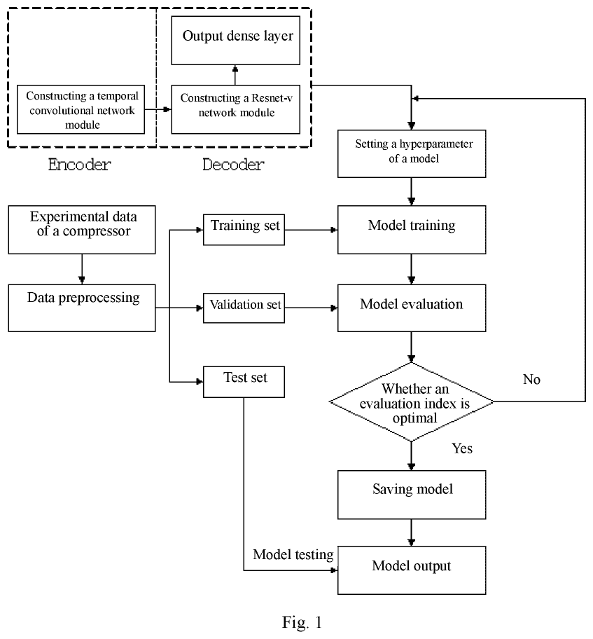

The present invention is further described below in combination with the drawings. The present invention replies on the background of experimental data of surge of a certain type of aero-engine. A flow of a pre-alarming method for rotary stall of compressors based on a temporal dilated convolutional neural network is shown in FIG. 1.

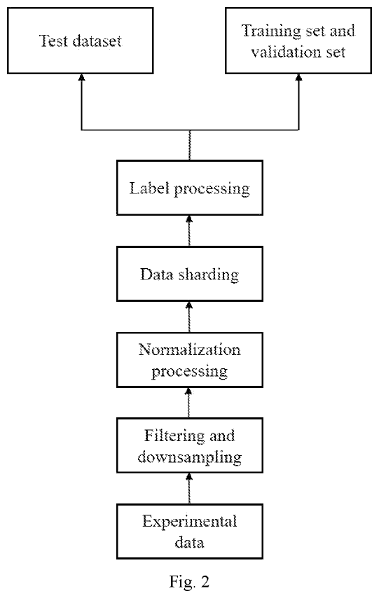

FIG. 2 is a flow chart of data preprocessing, 10 measuring points are set during experiment to measure dynamic pressure values from normal state to surge in t second(s), the sensor measurement frequency is 6 kHz, and a total of 16 sets of data are recorded; the 10 measuring points are respectively located on the tip region of an inlet guide vane stator, the tip region of a zero-stage stator, the tip region of first-stage stators (three in circumferential direction), the tip region of a second-stage stator, the tip region of a third-stage stator, the tip region of a fourth-stage stator, the tip region of a fifth-stage stator, and an outlet wall. The steps for data preprocessing are as follows:

S1. Conducting filtering processing on pressure variation data measured at all measuring points in a training dataset by a low pass filter;

S2. Conducting downsampling on the filtered data in order to save computing resources, and determining a downsampling rate according to numerical distribution interval of surge frequency and based on Nyquist sampling theorem;

S3. Conducting normalization processing on the downsampled data, and mapping data distribution to an interval [0, 1] by linear variation;

S4. Constructing a dataset sample by a sliding window technique, sharding time domain data in units of time steps with a size of “steps”, constituting a sample by sampling points covered by each data window, and attaching a label of 1 or 0 for surge or not to each sample; and

S5. Dividing an overall dataset into a training dataset and a test dataset, and then dividing the training dataset into a training set and a validation set with a ratio of 3:1.

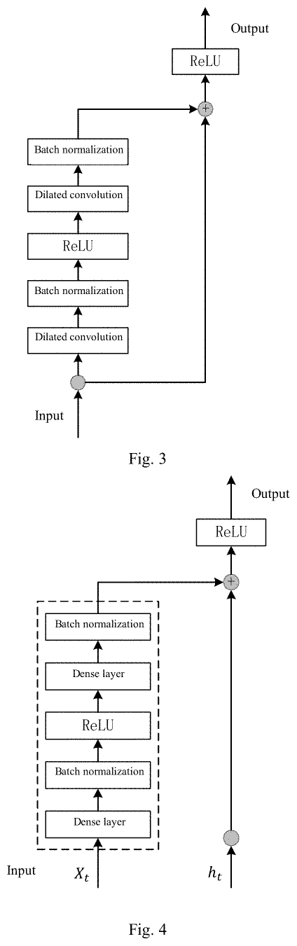

FIG. 3 is a structural diagram of a temporal convolutional network, and the steps for constructing a temporal convolutional network module are as follows:

S1. Adjusting dimension of each sample to (steps, 1), and taking same as an input of the temporal convolutional network module, wherein “steps” represents the size of the time steps;

S2. Constructing dilated convolutional modules based on causal convolution and dilated convolution, wherein basic modules in each layer of a temporal convolutional network are composed of two dilated convolutional modules with the same kernel size and dilated factor value. Setting the width k of the convolutional filter to 2, using 11 filters for each layer of convolution, making dilated factors of dilated convolutional layers be [1, 2, 4, 8, 16, 32] respectively, and making the reception field reach 128; conducting batch normalization after a first dilated convolution, introducing a rectified nonlinear unit ReLU to adjust information passed to a next layer, and conducting batch normalization again after a second dilated convolution. Adopting residual connection between the convolutional modules to directly forward characteristic information and avoid gradient disappearing. Summing the obtained characteristics of a current layer and the output characteristics of a previous layer by the residual connection, i.e., conducting an operation of xₗ₊₁=f(xₗ, wₗ)+xₗ, processing the obtained output by a ReLU activation function, and finally obtaining the output characteristics of the current layer;

S3. Constructing a temporal convolutional network by stacking multiple dilated convolutional modules, expanding network reception field, reserving output information of each convolutional layer by information superimposition, and obtaining an output of the temporal convolutional network module through activation by the ReLU activation function.

FIG. 4 is a structural diagram of a Resnet-v network, and the steps for constructing the Resnet-v network are as follows:

S1. Considering characteristics of the surge data, allowing two parts of data input in a designed Resnet-v network, wherein one part is historical data characteristics and the other part is data covariates; calculating time domain statistical characteristics of each sample, including the data characteristics such as variance, mean, maximum and minimum, and serial number of a measuring point corresponding to the sample, forming a set of covariate characteristics, and taking the covariate characteristics as one of the inputs of the Resnet-v network module;

S2. Processing input covariates through a set of dense layer and BN layer, and applying the ReLU activation function to pass the covariates to a next set of dense layer and BN layer; summing an output thereof and the data characteristics obtained by the temporal convolutional network, and obtaining an output of the Resnet-v network by the ReLU activation function.

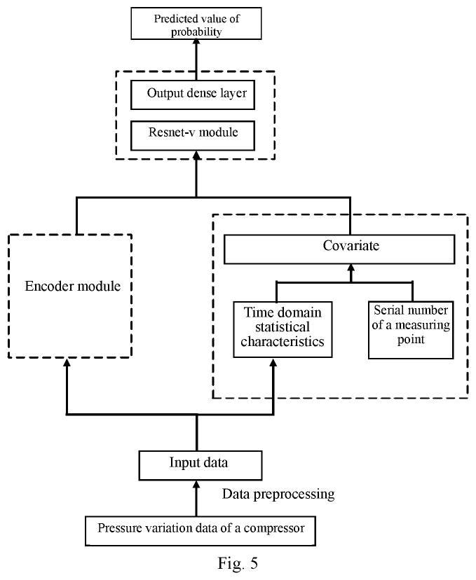

FIG. 5 is a structural diagram of a temporal dilated convolutional network prediction model, and the steps for constructing the temporal dilated convolutional network prediction model are as follows:

S1. Constructing a temporal dilated convolutional network prediction model by an architecture similar to Seq2Seq architecture, and dividing the model into an Encoder module and a Decoder module, wherein the Encoder module is a temporal convolutional network module, and the Decoder module is composed of a Resnet-v network module and an output dense layer;

An output of the Encoder module is:

$${h}_{t} = {\sum }_{k = 0}^{K - 1} w ( k ) x ( t - d \cdot k )$$

Where x is a current input time series, t represents the current moment, and w is a convolution kernel; d represents a dilated factor of the temporal convolutional network module, and K represents the size of the kernel; hₜ is a characteristic extracted from the input data at the moment t by the temporal convolutional network module, and represents the output of the Encoder module.

S2. Calculating a data covariate Xₜ, inputting the data covariate and the output characteristic hₜ of the Encoder module into the Resnet-v network module, and obtaining a fusion output as follows:

δₜ=R(Xₜ)+hₜ

Where hₜ is the output of the Encoder module, Xₜ is a covariate of the input data at the moment t, R(⋅) is a residual function applied to the covariate Xₜ, and δₜ represents an output of the Resnet-v network module.

S3. Receiving the fusion output δₜ obtained in the previous step by the output dense layer of the Decoder module, designing an operation mode of the output dense layer according to the requirements of a model prediction task, and processing by the dense layers, the BN layers, the activation function, etc. to obtain a predicted value of surge probability, as shown in the following formula:

Z=Dense(δₜ)

Where Dense refers to an output dense layer operation set according to the prediction task, which is specifically set to a “dense-BN-ReLU-Dropout-Soft ReLU” structure in the current surge probability prediction task, and the Soft ReLU activation function herein is used to satisfy positive qualitative conditions of parameters; and Z is an estimated value of the output predicted probability.

S4. Compressor surge data having the following problems, which will influence the model training effect to a certain extent:

Firstly, easy/hard samples are imbalanced, stall inception is usually spike-type stall inception, data are very stable before the spike-type stall inception comes but jitters violently after the surge occurs, and values vary greatly compared with those in an earlier stage, therefore these samples are easy to classify and belong to easy samples; while the samples in the process from spike-type stall inception to surge are relatively hard to identify because of having small fluctuation or having no fluctuation substantially. The time interval from stall inception to surge is short, and the development is rapid, therefore the proportions of easy/hard samples are imbalanced.

Secondly, for different influences caused by incorrect classification of different classes, as compared to the influence of classifying a non-surge state as a surge state, the actual cost caused by the influence of incorrectly classifying a surge state as a non-surge state is far higher than the former.

In order to solve the above problems, taking MHL (Modified HuberLoss) as a loss function.

As a loss function with a higher robustness, HuberLoss effectively combines the advantages of MSE and MAE, and avoids the problem of MAE being nondifferentiable when the value is 0 and the disadvantage of MSE being greatly influenced by outliers. A formula thereof is:

$${L}_{δ} ( y , f ( x ) ) = \{ \begin{matrix}\frac{1}{2} {( y - f ( x ) )}^{2} , & \vert y - f ( x ) \vert \leq δ \\ δ \vert y - f ( x ) \vert - \frac{1}{2} {δ}^{2} , & \vert y - f ( x ) \vert > δ\end{matrix}$$

In addition, in view of the problems caused by incorrect classification, introducing an influence factor β(β∈[0,1]) to represent influence degree of a sample in a surge state (category 1) being incorrectly classified as in a non-surge state (category 0), and defining a weight coefficient β₀₋₁ as:

$${β}_{0 - 1} = \{ \begin{matrix}β , & y = 1 \\ 1 - β , & y = 0\end{matrix}$$

Finally, a form of the loss function being MHL=β₀₋₁L_{δ}(y, f(x)).

S5. Saving a trained model and testing on the validation set, adjusting the hyperparameter of the model according to an evaluation index of the validation set, and adopting an F_score index as the evaluation index:

$${F}_{score} = ( 1 + {β}^{2} ) * \frac{P \cdot R}{{β}^{2} * P + R}$$

Where P is precision, which represents percentage of true positive samples in samples predicted as positive, i.e.,

$$P = \frac{TP}{TP + FP} ;$$

R is recall, which represents percentage of correctly predicted samples in the true positive samples, i.e.,

$$R = \frac{TP}{TP + FN} ;$$

TP is a true positive number, FP is a false positive number, and FN is a false negative number.

Because the loss caused by predicting a positive sample as a negative sample, i.e., predicting a surge sample as a non-surge sample is greater, setting β to 2, and increasing the importance of recall in the evaluation index. Saving a model which makes the evaluation index optimal, and obtaining a final temporal dilated convolutional network prediction model.

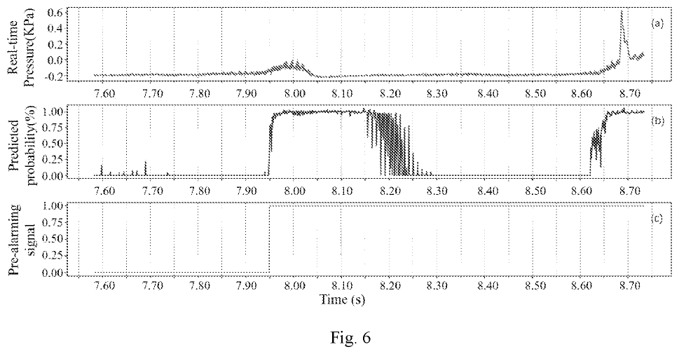

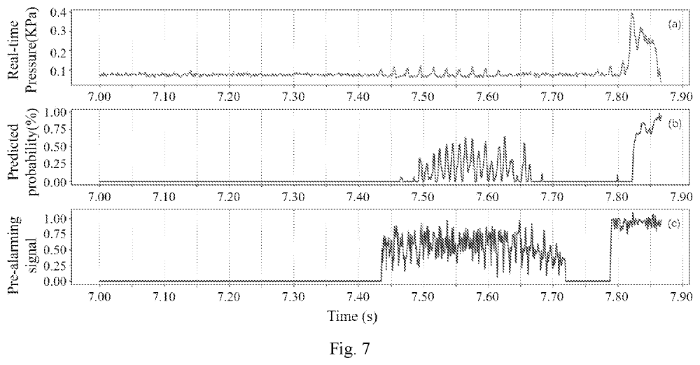

FIG. 6 is a diagram showing predicted results of a temporal dilated convolutional network prediction model on test data, wherein (a) is a diagram showing that dynamic pressure at a tip region of an inlet zero-stage stator varies in real time, (b) is a diagram showing that predicted surge probability given by the temporal dilated convolutional network prediction model varies in real time, and (c) is a diagram showing a pre-alarming signal given by the temporal dilated convolutional network prediction model. FIG. 7 is a comparison diagram showing influence of covariates on prediction effect of a temporal dilated convolutional network prediction model, wherein (a) is a diagram showing that dynamic pressure at a tip region of an inlet second-stage stator varies with time, (b) is a diagram showing that predicted surge probability varies with time when an input contains no covariates, and (c) is a diagram showing that predicted surge probability varies with time when the input contains covariates. The steps for conducting real-time prediction on test data are as follows:

S1. It can be seen from (a) of the diagram showing predicted results of dynamic pressure data at a tip region of a zero-stage stator that, upward spike-type stall inception appears at 7.95 s at the initial disturbance stage of stall; with the development of disturbance of stall, violent fluctuation appears at 8.65 s, which is thoroughly developed into stall and surge. Preprocessing test set data according to the steps for data preprocessing, adjusting data dimension, and inputting the data into a trained temporal dilated convolutional network prediction model to conduct prediction. It can be seen from FIG. 6(b) and FIG. 6(c) that, the surge probability is increased from 0 to 80% of the predicted value at about 7.95 s, is maintained at a high predicted value in the range of 7.95 s to 8.25 s, is decreased after 8.3 s as the original dynamic pressure data is in a relatively stable stage, and is increased again at 8.62 s following the fluctuation of the original data. According to the occurrence principle of surge, the occurrence of stall inception represents a high probability of rotary stall and surge; therefore, when stall inception is predicted at 7.95 s, a pre-alarming signal is given by a system in the initial disturbance stage to prevent damage to components.

S2. In the present invention, the time domain characteristic information contained in the historical data and the data covariates are comprehensively considered, so a control experiment is conducted on the improvement degree of the prediction effect by the covariates. It can be seen from diagram (a) of the diagram showing predicted results of dynamic pressure data at a tip region of a second-stage stator that, spike-type stall inception developing downward appears at 7.43 s at the initial disturbance stage of stall; with the development of disturbance of stall, violent fluctuation appears at 7.79 s, which is thoroughly developed into stall and surge. Also, preprocessing test set data according to the steps for data preprocessing, using a set of data containing covariate information and a set of data not containing covariate information, adjusting data dimension, and conducting prediction; FIG. 7(b) shows that without the assistance of covariate information, the surge probability is increased after about 7.49 s, which is 0.05 s later than the start point of the initial stage of stall; FIG. 7(c) shows that the surge probability is increased after 7.44 s, which is basically the same as the start point of the initial stage of stall; therefore, the covariate information is helpful to surge probability prediction to a certain extent.

The above embodiments only express the implementation of the present invention, and shall not be interpreted as a limitation to the scope of the patent for the present invention. It should be noted that, for those skilled in the art, several variations and improvements can also be made without departing from the concept of the present invention, all of which belong to the protection scope of the present invention.

1. A pre-alarming method for rotary stall of compressors based on a temporal dilated convolutional neural network, comprising the following steps:
S1. preprocessing surge data of an aero-engine, comprising the following steps:
S1.1. importing experimental data of a measuring point and taking the experimental data as a dataset to conduct filtering processing on pressure variation data;
S1.2. conducting downsampling on the filtered data;
S1.3. conducting normalization processing on the downsampled data, and mapping data distribution to an interval [0, 1] by linear variation;
S1.4. constructing a dataset sample, sharding time domain data in units of time steps with a size of “steps”, constituting a sample by sampling points covered by each data window, and attaching a label of 1 or 0 for surge or not to each sample;
S1.5. dividing an overall dataset into a training dataset and a test dataset, and then dividing the training dataset proportionally into a training set and a validation set;
S2. constructing a temporal convolutional network module, comprising the following steps:
S2.1. adjusting dimension of each sample to (steps, 1), and taking same as an input of the temporal convolutional network module, wherein “steps” represents the time steps;
S2.2. constructing dilated convolutional modules based on causal convolution and dilated convolution, wherein basic modules in each layer of a temporal convolutional network are composed of two dilated convolutional modules with the same kernel size and dilated factor value; conducting batch normalization after a first dilated convolution, introducing a rectified nonlinear unit ReLU to adjust information passed to a next layer, conducting batch normalization again after a second dilated convolution, summing obtained characteristics and characteristics extracted from a previous layer, and calculating output characteristics of a current layer by a ReLU activation function;
S2.3. constructing a temporal dilated convolutional neural network by stacking multiple dilated convolutional modules, expanding network reception field, reserving output information of each convolutional layer by skip connection, and obtaining an output of the temporal convolutional network module through activation by the ReLU activation function;
S3. constructing a Resnet-v network module, comprising the following steps:
S3.1. considering characteristics of the surge data, allowing two parts of data input in a Resnet-v network, wherein one part is historical data characteristics and the other part is data covariates; calculating time domain statistical characteristics of each sample and serial number of a measuring point corresponding to the sample, forming a set of covariate characteristics, and taking the covariate characteristics as one of the inputs of the Resnet-v network module;
S3.2. processing input covariates through a set of dense layer and BN layer, and applying the ReLU activation function to pass the covariates to a next set of dense layer and BN layer; summing an output thereof and the data characteristics obtained by the temporal convolutional network, and obtaining an output of the Resnet-v network by the ReLU activation function;
S4. constructing a temporal dilated convolutional network prediction model, comprising the following steps:
S4.1. constructing a temporal dilated convolutional network prediction model, and dividing the model into an Encoder module and a Decoder module, wherein the Encoder module is a temporal convolutional network module, and the Decoder module is composed of a Resnet-v network module and an output dense layer;
S4.2. inputting an output characteristic hₜ of the Encoder module into the Resnet-v network module, and conducting an operation according to step S3 to obtain a fusion output;
S4.3. receiving the fusion output obtained in the previous step by the output dense layer of the Decoder module, and processing by the dense layers, the BN layers and the ReLU activation function in sequence to obtain a predicted value of surge probability;
S4.4. in view of problems in surge data training, taking MHL as a loss function, with a formula thereof being:
$${L}_{δ} ( y , f ( x ) ) = \{ \begin{matrix}\frac{1}{2} {( y - f ( x ) )}^{2} , & \vert y - f ( x ) \vert \leq δ \\ δ \vert y - f ( x ) \vert - \frac{1}{2} {δ}^{2} , & \vert y - f ( x ) \vert > δ\end{matrix}$$
where y represents a real data value, f(x) represents a currently predicted value, δ is a hyperparameter that determines how to calculate an error, and L_{δ}(y, f(x)) is a currently calculated loss value;
in addition, introducing an influence factor β(β∈[0, 1]) to represent influence of a sample in a surge state being incorrectly classified as in a non-surge state, and defining a weight coefficient β₀₋₁ as:
$${β}_{0 - 1} = \{ \begin{matrix}β , & y = 1 \\ 1 - β , & y = 0\end{matrix}$$
finally, a form of the loss function being MHL=β₀₋₁L_{δ}(y, f(x));
S4.5. saving a trained model and testing on the validation set, adjusting the hyperparameter of the model according to an evaluation index of the validation set, adopting an F_score index as the evaluation index, saving a model which makes the evaluation index optimal, and obtaining a final temporal dilated convolutional network prediction model;
S5. conducting real-time prediction on test data
S5.1. obtaining test set data divided after preprocessing in step S1, and adjusting dimension of the data according to input requirements of the temporal dilated convolutional network prediction model;
S5.2. calculating predicted surge probability of each sample by a trained temporal dilated convolutional network prediction model, and sorting in chronological order;
S5.3. randomly selecting a set of dynamic pressure data from the test data, sorting the data input to the model into a set of control samples with covariable parameters and a set of control samples without covariable parameters, and using the trained temporal dilated convolutional network prediction model to respectively give real-time surge probabilities of two sets of control data.

2. The pre-alarming method for rotary stall of compressors based on a temporal dilated convolutional neural network according to claim 1, wherein in step 1.2, selecting a downsampling rate according to numerical distribution interval of surge frequency and based on Nyquist sampling theorem.

3. The pre-alarming method for rotary stall of compressors based on a temporal dilated convolutional neural network according to claim 1, wherein in step 1.5, ratio of the training set to the validation set is 3:1.

4. The pre-alarming method for rotary stall of compressors based on a temporal dilated convolutional neural network according to claim 1, wherein the F_score index in step S4.5 is as follows:
$${F}_{score} = ( 1 + {β}^{2} ) * \frac{P \cdot R}{{β}^{2} * P + R}$$
where P is precision, which represents percentage of true positive samples in samples classified as positive:
$$P = \frac{TP}{TP + FP} ,$$
TP is a true positive number, and FP is a false positive number; R is recall, which represents percentage of correctly predicted positive samples in the samples:
$$R = \frac{TP}{TP + FN} ,$$
TP is a true positive number, and FN is a false negative number; β is 2.
